(19) United States
(12) Patent Application Publication
(10) Pub. No.: US 2022/0281172 A1
(43) Pub. Date: Sep. 8, 2022

(54) Methods And System For Removal Of Unwanted Material From An Additively Manufactured Object

(71) Applicant: PostProcess Technologies, Inc., Buffalo, NY (US)

(72) Inventor: Daniel Joshua Hutchinson, Orchard Park, NY (US)

(73) Assignee: PostProcess Technologies, Inc., Buffalo, NY (US)

(21) Appl. No.: 17/625,723

(22) PCT Filed: Jul. 9, 2020
(86) PCT No.: PCT/US2020/041396

§ 371 Date: Jan. 7, 2022

Related U.S. Application Data
(60) Provisional application No. 62/872,594, filed on Jul. 10, 2019.

(51) Int. Cl. B29C 64/357; B08B 3/12; B29C 64/386; B29C 64/245; B33Y 40/00; B33Y 10/00

(52) U.S. Cl. CPC B29C 64/357; B08B 3/12; B29C 64/386; B29C 64/245; B33Y 40/00; B33Y 10/00; B33Y 50/02

(57) ABSTRACT

Systems and methods according to the invention are used for removal of unwanted material from an additively manufactured object by application of sonic energy are disclosed. Application of sound at specific frequencies, specific amplitudes and specific waveforms to specific materials causes physical displacement of such materials. When applied to objects formed by additive manufacturing and unwanted material formed with such objects, the displacement causes the unwanted material to break away from the object. Advantageously, the unwanted material removed from the additively manufactured object can be recycled.

### CROSS REFERENCE TO RELATED APPLICATION

This application claims priority to U.S. Ser. No. 62/872,594 filed Jul. 10, 2019, the entire disclosure of which is incorporated by reference herein.

### FIELD OF THE INVENTION

This disclosure relates generally to additive manufacturing and in particular to a system and method for removing unwanted material, such as support material or powder, from an object made by a 3D printer in a printing stage of the overall additive manufacturing process.

### BACKGROUND OF THE INVENTION

In some kinds of additive manufacturing processes (also referred to as 3D printing processes), such as Selective Laser Sintering (SLS), Electron Beam Melting (e-beam), or Powder Bed Fusion (PBF), solid objects are manufactured using a computer-controlled beam or print head to fuse or solidify the portions (such as the walls) of the object a layer at a time until the entire three-dimensional object is formed. After the solid three-dimensional object is formed, unwanted material, such as a powder from which the object was formed, may cling to or encase the solid object. It is necessary to remove this unwanted material from the solid printed object before the next step, which may include painting, passivation, coating, assembly, and so on. In some other additive manufacturing processes printed objects have unwanted material on them after the printing stage, including support material. Some additively manufactured objects have rough surfaces or build lines after being formed by the printer.

Additional disclosure about prior techniques and processes for additive manufacturing and removal of unwanted material from objects formed in the printing stage can be found in copending patent applications, Ser. Nos. 16/209,778, 16/232,955, 16/340,647, 16/298,550, and 15/611,435, which are assigned to the owner of the present application and the entire disclosures of which are incorporated by reference herein.

### SUMMARY OF THE INVENTION

A system and method for removal of unwanted material from an additively manufactured object by application of sonic energy are disclosed. Application of sound at specific frequencies, specific amplitudes and specific waveforms to specific materials causes physical displacement of such materials. When applied to objects formed by additive manufacturing and unwanted material formed with such objects, the displacement causes the unwanted material to break away from the object. Advantageously, the unwanted material removed from the additively manufactured object can be recycled.

### BRIEF DESCRIPTION OF THE FIGURES

FIG. 1 is a cutaway side view showing a system incorporating features of a first embodiment.

FIG. 2 is a cutaway side view of the embodiment shown in FIG. 1 into which objects encased in unwanted support material have been placed.

FIG. 3 is a top view of the platform of the system of FIG. 1.

FIG. 4 is a block diagram showing some component data elements of the database shown in FIGS. 1 and 2.

FIG. 5 shows different waveforms that can be applied to the audio transducers of FIGS. 1 and 2.

FIG. 6 is a flowchart showing a process performed by the system of FIGS. 1 and 2.

FIG. 7 is a flowchart showing another process performed by the system of FIGS. 1 and 2.

A list of features shown in the FIGS. is:

100 system

102 chamber

104 door

108 platform

110 objects

112 unwanted material

114 audio transducers

116 cameras

118 scale

120 sensors

130 openings

144 chute

146 hatch

148 chamber opening

170 controller

176 housing

178 programming

180 user interface

188 amplifier

190 profile database

194 profiles

### DETAILED DESCRIPTION OF THE INVENTION

Although the invention will be described in terms of certain examples, other examples, including examples that do not provide all of the benefits and features set forth herein, are also within the scope of the invention. Various changes to the system and method may be made without departing from the scope of the invention.

A system and method for removal of support material from an additively manufactured object by application of sonic (also referred to as “acoustic”) energy are disclosed. Application of sound at specific frequencies (or pitches), specific amplitudes and specific waveforms to specific materials causes physical displacement (e.g., including but not limited to vibration) of such materials. The relationships between frequencies, amplitudes and waveforms and the displacement of such materials are part of the field of cymatics. Sound is the propagation of a vibrational wave through a medium. A vibrational wave includes successive regions of higher and lower pressure that propagate at a rate in the medium. The waves of successive higher and lower pressure impart mechanical energy to physical objects in the medium, which in turn can cause physical displacement of the objects. When applied to objects and support material formed by additive manufacturing, the displacement causes the support material to break away from the object. Advantageously, the support material removed from the additively manufactured object can be recycled.

When applied to removal of support material from additively manufactured objects, selection of an appropriate sonic frequency may take into account various factors, including the resonant frequencies of the embedded object(s) and the encasing support material. The resonant frequencies may be dependent on the material composition of the object(s) and the support material, the size, geometry, and density of the object(s) and the support material, as well as other factors. Methods for determining an appropriate frequency for removal of unwanted material from additively manufactured objects are disclosed in copending patent application Ser. No. 16/348,276, the entire disclosure of which is incorporated by reference herein.

As used herein, unless otherwise indicated, the term support material refers to material that is operatively arranged to support portions of an object during an additive manufacturing process, but which is undesired once the manufacturing process is complete. Support material can comprise the same material as the object that is being manufactured, or can be made of a different material. Support material can be physically attached to the object or can surround all or portions of surfaces of the object without true physical attachment but in a manner where the support material is stuck to the object in a way that requires force to remove it. Support material may include material that does not physically support the formed physical object, but may be material such as a powder from which the object was formed and which clings to the object after the object has been formed.

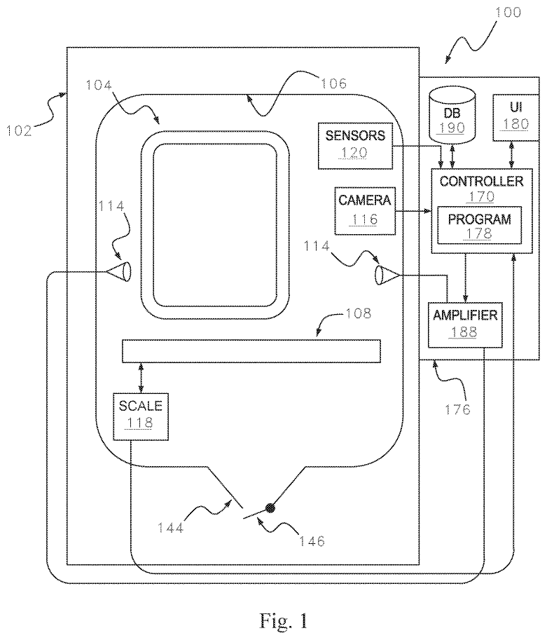

An embodiment is shown in FIG. 1. FIG. 1 shows a system 100 that includes a chamber 102. The chamber 102 has a door 104 that can be opened and closed. The door 104 provides access to an interior 106 of the chamber 102. The door 104 may include sealing around it to prevent or reduce air or sound leakage from the chamber 102. The chamber 102 has a size suitable for containing therein additively manufactured objects, including the unwanted material (such as support material) formed in that portion of the additive manufacturing process performed by a 3D printer. In one embodiment, the chamber is approximately 1 meter by 1 meter by 1 meter. Other sizes may be suitable. The chamber 102 and door 104 may be made of a suitable, durable material such as stainless steel.

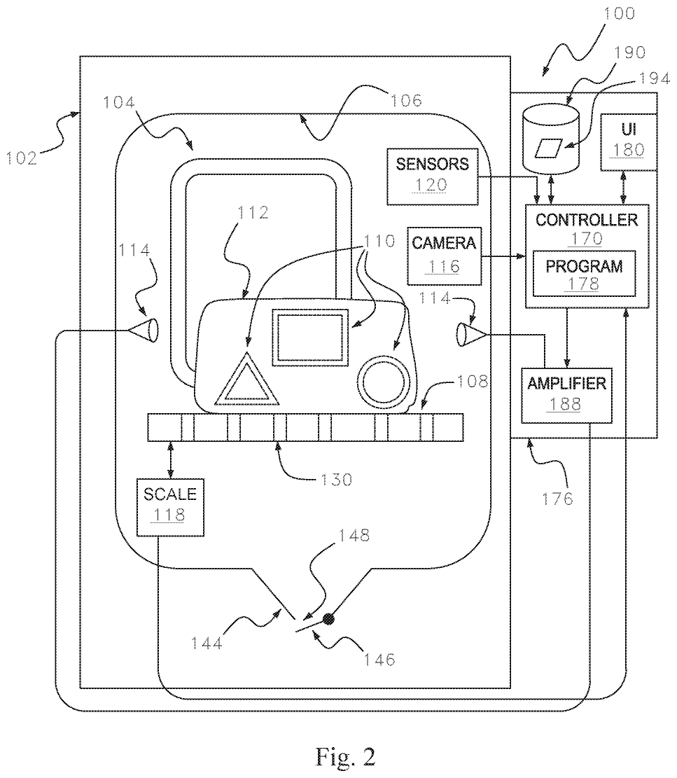

Located inside the chamber 102 is a platform 108. The platform 108 may be made of a suitable, durable material such as stainless steel. As shown in FIG. 2, the platform 108 may be sized and adapted for having placed thereupon one or more objects 110 that had been formed by an additive manufacturing process. When formed by the additive manufacturing process, the objects 110 have support material 112 remaining thereupon. In this example, the support material 112 is a powder resin. Further, when formed by this additive manufacturing process, the objects 110 are encased in the powder resin support material 112.

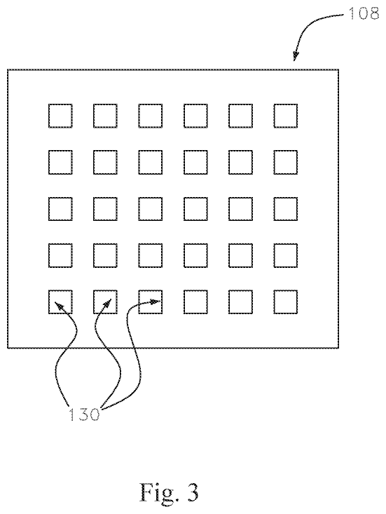

As shown in FIG. 3, the platform 108 has openings 130 located therein. The openings 130 are located in the platform 108 so that any material falling off objects located on the platform 108 will fall though the openings 130.

Referring again to FIGS. 1 and 2, mounted in the chamber 102 are one or more audio transducers 114. The audio transducers 114 may be horns, speakers, diaphragms, vibratory plates or membranes, or other devices capable of forming audio (i.e., sonic, acoustic) waves. The audio transducers 114 are adapted to provide audio waves in the air inside the chamber 102. The audio transducers 114 are adapted to provide audio waves at different frequencies and amplitudes based on signals input thereto. In this embodiment, the audio transducers 114 are mounted and oriented to project audio waves at the objects 110 mounted on the platform 108.

Located inside the chamber 102 are one or more cameras 116. The cameras 116 are directed at areas above the platform 108 so as to capture imagery (e.g., video, pictures) of anything on the platform 108.

Located inside the chamber 102 is a scale 118. The scale 118 is mounted to the platform 108 and is adapted to measure the weight of anything on the platform 108.

Also located inside the chamber 102 are additional sensors 120. These additional sensors 120 may include one or more microphones, thermometers, scanners, and so on. These additional sensors 120 are adapted to measure properties of anything on the platform 108 or in the chamber 102. For purposes of this disclosure, the scale 118 and the cameras 116 are considered to be sensors 120.

Located in the bottom floor of the chamber 102 is a discharge chute 144. A hatch 146 covers an opening 148 located at the bottom end of the discharge chute 144.

The system 100 includes a controller 170. The controller 170 is located outside the chamber 102. In this embodiment, the controller 170 is located adjacent the chamber 102 in another housing 176. In alternative embodiments, the controller 170 may be located remotely. The controller 170 is operatively connected to the hardware of system 100, including the transducers 114, the cameras 116, the sensors 120 and the scale 118. In this embodiment, the controller 170 is a personal computer (PC) running a suitable operating system, such as the Windows® operating system.

The controller 170 includes appropriate programming 178 by which the system 100 can be operated, as explained below.

The system 100 includes a user interface 180. The user interface 180 includes a touch screen or other hardware for receiving input from a (human) user and providing information output to the user. In the embodiment shown in FIGS. 1 and 2, the user interface 180 is shown located on the housing 170. In alternative embodiments, the user interface 180 may be located elsewhere, including remotely. The user interface 180 is connected to the controller 170.

Operatively connected to the controller 170 is an amplifier 188. The amplifier 188 is also connected to the audio transducers 114.

The system 100 also includes a profile database 190. The profile database 190 is a data storage adapted to contain various different operational profiles 194. The operational profiles 194 are comprised of stored data that includes operating parameters for different objects to be placed in the system 100 for removal of unwanted material. The profile database 190 is operatively connected to the controller 170. The profile database 190 may be located with the controller 170 in the housing 176 or may be located remotely. The profile database 190 is adapted to exchange data with the controller 170.

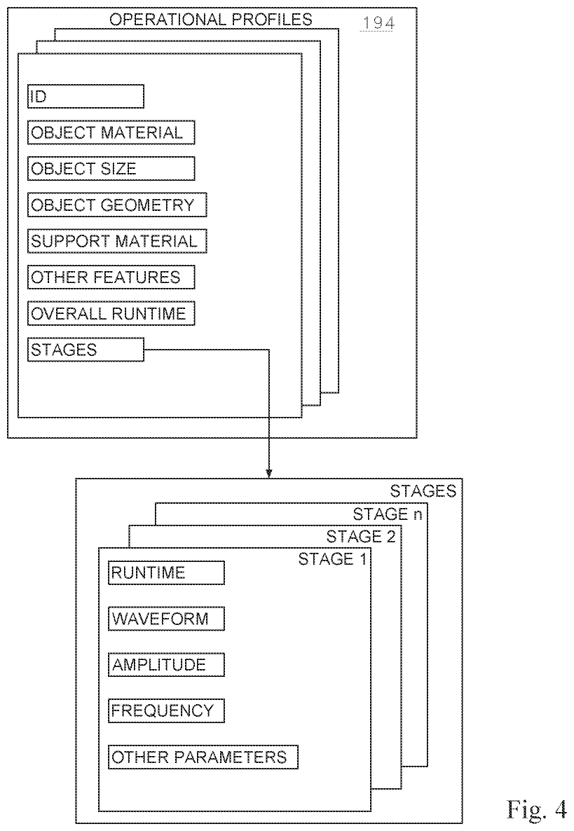

FIG. 4 shows a diagram illustrating components of operational profiles 194 in the profile database 190. Operating parameters are associated with different additively manufactured objects and different object characteristics including part size, geometry and material, additive manufacturing process used to make the part, support material size, geometry and material composition. The operating parameters for each different object and different object characteristic may include runtime, temperature, sonic waveform, sonic amplitude, sonic frequency and possibly other parameters. In this embodiment, the runtime may indicate the total duration of time that sonic energy is applied to an object in the chamber. In some alternatives, the runtime may include multiple stages having different durations during which the temperature, sonic waveform, sonic amplitude, sonic frequency and possibly other parameters may be changed. In some embodiments, the operational profiles are fixed. In other embodiments, some or all the operating parameters are dynamic, that is, the duration of the entire runtime or any of the stages of the entire runtime can be adjusted during operation by the controller based on input from the cameras 116, scale 118, and/or other sensors 120. In some embodiments, some or all the operating parameters are infinitely variable, that is, the parameter can be set to any value within its range of operation.

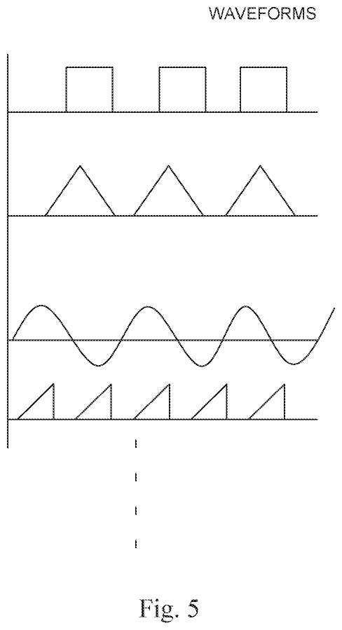

Among the operating parameters are waveform profiles. Depending on the characteristics of the additively manufactured objects, different sonic waveforms may be suitable of removal of unwanted material. Some of these waveforms are shown in FIG. 5.

### Operation Embodiments

Interactive Mode.

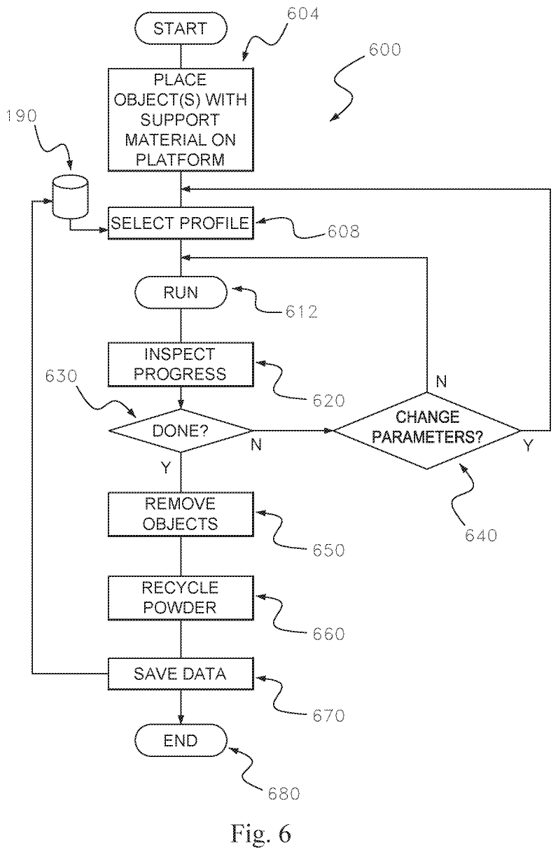

FIG. 6 shows a flowchart of a process 600 performed by or with the system of FIGS. 1 and 2. The process 600 in FIG. 6 includes interactive steps in which a user (operator) interacts with the system 100. In step 604, objects encased in unwanted support material (e.g., powder) are placed in the system 100, specifically on the platform 108 inside the chamber 102. After the objects encased in unwanted support material are placed in the chamber, the door 104 is closed.

In step 608, a profile is selected. This step may be performed by a user via the user interface 180. Programming 178 on the controller 170 may present profiles to the user on the user interface 180. When selecting a profile, the user may take into account characteristics of the objects, the support material and the additive manufacturing process used to form the objects and support material.

After the profile is selected, the system begins application of sonic energy to the object and support material (Step 612).

In this interactive mode of operation, the user checks the progress of the material removal process (Step 620). This can be done by stopping the application of sonic energy, opening the door and observing the objects and material removal. Alternatively, the progress can be checked by observing the objects and material removal through a window viewing panel, or by viewing imagery from the camera displayed on the user interface. If upon inspection, the user determines that additional material removal is needed, the sonic energy is applied again to the object in the chamber (Step 630). The user may use the same frequency, amplitude and waveform or may choose a different frequency, amplitude and/or waveform (Step 640) depending on the progress of the material removal, as well as other factors.

If the user determines upon inspection that the unwanted material is sufficiently removed from the additively manufactured object (Step 630), the object is removed from the chamber (Step 650). The object is then ready for use, or the object may be ready for another step, such as washing, painting, passivation, assembly, and so on.

During the removal process, as unwanted material is removed from the object(s) it falls through the openings in the platform 108 and into the chute 144. In Step 660, the support material that had been removed from the object(s) in the chamber is removed and recycled. This may be done via the chute 144 at the bottom of the chamber 102.

In Step 670, information about the material removal operation cycle is saved to the database 190.

In this embodiment, the programming on the controller stores information about the process used for removal of unwanted material from the additively manufactured object. This information includes data about the material composition of the object and the unwanted material, the size and geometry of the object and the unwanted material, the frequencies, amplitudes and waveforms used for material removal, the duration of time each frequency, amplitude and waveform was used, as well as any other information. All this information is stored. This information is used by a program that creates the profiles. Using the information stored for process of removal of unwanted material from an additively manufactured object, one or more profiles are then formed for subsequent material removal for the same or similar additively manufactured objects. Such stored profiles may be used in the fully automated mode described below.

After the operation data is stored, the process ends (Step 680).

Fully automated mode.

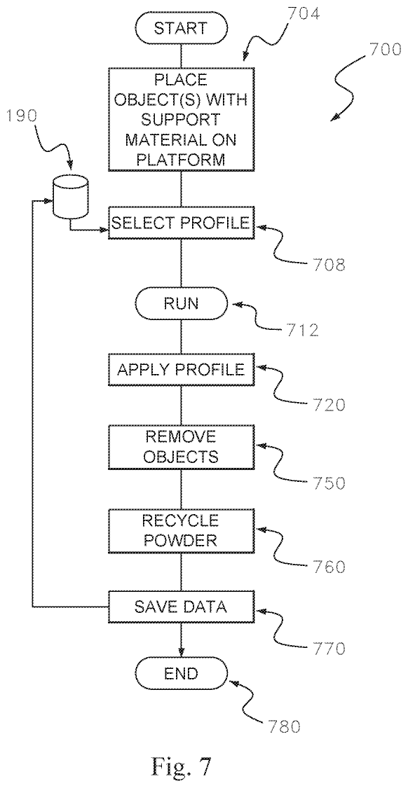

FIG. 7 shows a flowchart of a process 700 performed by or with the system 100 described in FIGS. 1 and 2. The process 700 shows steps of operation in a fully automatic mode. In step 704, objects encased in support material are placed in the system 100, specifically on the platform 108 inside the chamber 106. After the objects encased in powder are placed in the system, the door 104 is closed.

In step 708, a profile is selected. This step may be performed by a user via the user interface 180. When selecting a profile, the user may take into account characteristics of the objects, the support material and the additive manufacturing process used to form the objects and support material. When selecting a profile, information about different profiles is obtained from the profile database 190.

After the profile is selected, the system begins application of sonic energy to the object and support material (Step 712).

In this mode of operation, the system 100 operates without user interaction. In this mode of operation, the audio transducers apply the sonic energy to the object according to the selected profile (Step 720). In this mode of operation, if the profile calls for changing the waveform, frequency or amplitude at specific times for different stages, the controller causes the audio transducers to make the appropriate changes at the specified times.

In this fully automatic mode of operation, the system 100 stops applying sonic energy to the object at the time specified by the profile. The user then removes the object(s) from the platform (Step 750). At this point the additively manufactured object(s) are free of unwanted material. The additively manufactured object(s) are ready for use or for other processes, e.g., painting, etc.

In Step 760, the unwanted material that had been removed from the object(s) in the chamber is removed and recycled. This may be done via the chute 144 at the bottom of the chamber 102.

In Step 770, information about the material removal operation cycle is saved to the database 190.

After the operation data is stored, the process ends (Step 780).

Alternatives

In an embodiment described above, the system operates without application of other material removal technologies. In an alternative embodiment, a system using audio transducers to apply mechanical energy via pressure waves for removal of unwanted material may also use other technologies to supplement, augment or complement unwanted material removal. Such other technologies may include application of pressurized sprays (liquid, solids, or gaseous) or application of chemicals, such as detergents. These other technologies may be incorporated into the same system or chamber that includes the audio transducers or may be located in another chamber located adjacent to or in-line with the chamber that includes the audio transducers.

In the embodiment shown in FIGS. 1 and 2, the audio transducers 112 are described as being horns, membranes, diaphragms or speakers. In another embodiment, the walls of the chamber 102 can create the sound waves. In this alternative, the walls of the chamber are formed with the property that they can be made to vibrate at controlled frequencies and amplitudes when driven by an electric signal from the controller. In this embodiment, the walls of the chamber function as the audio transducer.

In another alternative, the audio transducers may be movable or pivotable. In this alternative, the audio transducers may be moved, pivoted or oriented to direct sound at different locations inside the chamber or along the object(s) or unwanted material on the platform. The directions at which the audio transducers are oriented may change during runtime of a material removal process, such as at different stages. The directions at which the audio transducers are oriented may be included in the information in the profile. The acoustic energy being transmitted by the audio transducers may be omni-directional, uni-directional, or a combination thereof. The directionality may be changed during the material removal process according to the operating profile. The audio transducers may include one or more wave guides or other means to facilitate directing the acoustic energy.

In different embodiments, the signal applied to the audio transducers may be a direct current or an alternating current.

As described above in connection with FIG. 2, the platform 108 is disclosed as having openings 130 so that any material falling off objects will fall through to the bottom of the chamber 102. The openings may be of any suitable type, including without limitation a mesh construction. Instead of openings, the platform may be made of other construction that allows material falling off objects to fall to the bottom of the chamber 102. Alternatively, a vacuum or other exhaust system could be used to capture the material falling of objects and remove it from the chamber.

In embodiments disclosed above, the removal of unwanted material from an additively manufactured object can be conducted at room temperature. In alternative embodiments, heat may be applied in conjunction with sonic energy to facilitate removal of unwanted material from an additively manufactured object. To apply heat to facilitate removal of unwanted material from an additively manufactured object, a heating element may be included in the chamber of the system shown in FIG. 1. The heater may be operated under control of the controller based on information contained in a profile 194. Alternatively, heater may be operated based on input provided by a user through the user interface. In still further alternative embodiments, the system may include a cooling element to cool or refrigerate the air in the chamber during the material removal process. The cooling element may be operated under control of the controller based on information contained in a profile or may be operated based on input provided by a user through the user interface. In further alternatives the system may include both a heating element and a cooling element.

In various different embodiments, different kinds of waveforms, different frequencies of waves, and different amplitudes of waves may be used. Different kinds of waveforms include sine waves, square waves, sawtooth waves, as well as others. In some alternatives, multiple different waveforms, multiple different amplitudes, multiple different frequencies of waves, or combinations thereof, may be applied at the same time to an object in the chamber. When applying different waveforms, amplitudes or frequencies, the different waveforms, amplitudes or frequencies may be applied from the same audio transducers(s) or alternatively, different audio transducers may each apply a different waveform, amplitude or frequency. The frequency of the sonic energy being applied may be in the audible range, the ultrasonic range, or any other range. In one embodiment, the frequency applied is 440 hertz, although other frequencies may be used.

In an embodiment described above, the audio transducers are connected to and driven by an amplifier. In alternative embodiments, a generator or other device may be used to drive the audio transducers to produce the acoustic energy.

In some of the embodiments described above, the interior of the chamber is maintained at atmospheric pressure. In other alternatives, the chamber may be maintained at a pressure that is higher or lower than atmospheric pressure, including near vacuum pressures. Alternatively, the pressure in the interior of the chamber may be changed during the material removal process. The pressure changes and the timing of the changes may be specified in the profile.

In some of the embodiments above, the controller was described as being a personal computer. In alternative embodiments, other programmable computers and other operating systems may be used.

In the embodiments described above, an operating profile was selected by the user. In another alternative, the user may specify some or all the operating parameters manually. In another alternative, the operating parameters may be specified by the entity that performed the 3D printing portion of the additive manufacturing process.

In another alternative, the system automatically measures the progress of unwanted material removal while the material is being removed, and automatically auto-adjusts the operating parameters to improve or complete the removal process. This alternative may employ the AUTOMAT3D™ technology developed by PostProcess Technologies, Inc. An embodiment of this technology is disclosed in copending patent application Ser. No. 16/348,276, the entire disclosure of which is incorporated by reference herein. Sensors in the chamber measure the progress of the material removal process and feedback this information to a digital file that is used to modify or adjust the operating parameters.

In still another alternative, the material removal system is part of an overall additive manufacturing system that includes the object formation portion as well as the unwanted material removal portion. According to this alternative, the design file for object formation (e.g., a CAD file) and the operating profiles for material removal are part of an overall design file that both forms the object and removes unwanted material. In such an alternative, object formation and unwanted material removal are designed together for overall optimization and efficiency of object manufacturing. One alternative is the CONNECT3D™ technology developed by PostProcess Technologies, Inc. An embodiment of this technology is disclosed in copending patent application Ser. No. 16/298,550, the entire disclosure of which is incorporated by reference herein. In some automated embodiments, the material removal process may be performed without user input or in a closed loop. Further, in some embodiments of an overall additive manufacturing system, the object may be moved on a conveyor, by robotic arm, or other means from the location where the object is formed to another location where acoustic energy is applied to remove unwanted material. In still other embodiments, acoustic energy is applied to remove unwanted material from an additively manufactured object in the same location (e.g., chamber) where the object is formed.

In some of the embodiments, the interior walls of the chamber are anechoic, or otherwise adapted so as to enhance or not detract from delivery of acoustic energy to the object(s) and material on the platform.

In embodiments described above, the medium inside the chamber is air. In alternative embodiments, other fluid media either gaseous or fluid may be used inside the chamber.

In the embodiments disclosed above, the platform is stationary and the objects located thereupon are likewise stationary. In alternative embodiments, the platform may be movable, e.g., a rotating turntable. Alternatively, the platform may vibrate continuously or intermittently, for example to facilitate powder removal. Movement of the platform may be specified in the operating profile.

Advantages

The disclosed embodiments have several advantages. One advantage is that the unwanted support material can be readily recycled. Compared to material removal systems that use a liquid spray, the disclosed embodiments provide for relatively easier recovery of removed material for recycling. Compared to material removal systems that use a liquid spray, the disclosed embodiments do not require filtering of the liquid after spraying for reuse, recovery or recycling of the liquid and/or recycling of the removed material. Compared to material removal systems that use a gaseous spray (e.g., air, shop air), the disclosed embodiments do not require filtering of the air to removed material entrained therein. Still another advantage is that the disclosed system removes unwanted material from an additively manufactured object without contact with the object. Compared to material removal systems that use application of chemicals, the disclosed embodiments have the advantage that the unwanted material is removed from additively manufactured objects without having the objects come in contact with any chemicals. Furthermore, compared to material removal systems that use application of chemicals, the disclosed embodiments avoid the costs (including disposal costs) of such chemicals. Compared to material removal systems that use abrasion with solids (e.g., application of a spray of entrained solid particles in a fluid or use of sandpaper), the disclosed embodiments have the advantage that the additively manufactured objects do not come in contact with the abrasive, which may affect the surface of the objects.

Having provided details of the invention, the following statements may be viewed as summarizing some of the aspects of the invention described above.

Statement 1 (“S1”). A system for removal of unwanted material from an additively manufactured object comprising:
a support platform for holding the additively manufactured object; and
at least one audio transducer that applies sonic energy the additively manufactured object on the support platform, whereby the unwanted material around the additively manufactured object is removed.

Statement 2 (“S2”). The system of S1 further comprising at least one camera oriented to capture imagery of the additively manufactured object on the support platform.

Statement 3 (“S3”). The system of S1 or S2 further comprising at least one scale adapted to weigh the additively manufactured object and/or the unwanted material on the support platform.

Statement 4 (“S4”). The system of S1, S2, or S3 further comprising at least one additional sensor, wherein the at least one additional sensor comprises a microphone, a thermometer, or a scanner.

Statement 5 (“S5”). The system of any of the foregoing Statements, further comprising:
an amplifier operatively connected to the at least one audio transducer; and
a controller operatively connected to the amplifier, wherein the controller outputs a signal that applies operating parameters for causing the amplifier to power the at least one audio transducer.

Statement 6 (“S6”). The system of any of the foregoing Statements, further comprising:
a profile database containing recipes, wherein each recipe associates operating parameters for operating the at least one audio transducer with at least one characteristic of different additively manufactured objects or unwanted material associated with different additively manufactured objects, and
a controller operatively connected to the profile database and the at least one audio transducer, wherein the controller is operatively adapted to output a signal that applies the operating parameters in a recipe selected from the profile database to the at least one audio transducer.

Statement 7 (“S7”). The system of any of the foregoing Statements further comprising a chamber containing the support platform and the at least one audio transducer, wherein an interior wall of the chamber is anechoic.

Statement 8 (“S8”). The system of S7 further comprising a discharge chute having a hatch that covers an opening located at a bottom of the chamber.

Statement 9 (“S9”). The system of S7 or S8 further comprising a heater located in the chamber.

Statement 10 (“S10”). The system of any of the foregoing Statements further comprising at least one wave guide associated with the at least one audio transducer and operative to facilitate directing the sonic energy.

Statement 11 (“S11”). A method for removal of unwanted material from an additively manufactured object comprising:
placing the additively manufactured object on a platform in a chamber, and
directing sonic energy at the additively manufactured object located on the platform, whereby the unwanted material around the additively manufactured object is removed.

Statement 12 (“S12”). The method of S1l further comprising:
selecting a profile that associates at least one characteristic of the additively manufactured object with at least one operating parameter for applying the sonic energy,
wherein the at least one characteristic of the additively manufactured object is one of: a size of, a geometry of, a material composition of, or a process used to manufacture the additively manufactured object or the unwanted material around the additively manufactured object, and
wherein the at least one operating parameter is one of: a runtime, a temperature, a sonic waveform, a sonic amplitude, or a sonic frequency, and
wherein the step of directing sonic energy further comprises directing the sonic energy with the at least one operating parameter in the selected profile.

Statement 13 (“S13”). The method of S11 or S12 further comprising removing the unwanted material from the chamber.

Statement 14 (“S14”). The method of S11, S12, or S13 further comprising recycling the unwanted material removed from the additively manufactured object.

Statement 15 (“S15”). The method of S11-S13, or S14 further comprising spraying a liquid chemical detergent at the additively manufactured object located on the platform.

Statement 16 (“S16”). The method of S11-14, or S15 further comprising changing direction at which the sonic energy is directed at the additively manufactured object located on the platform.

Statement 17 (“S17”). The method of S11-S15, or S16 wherein the sonic energy is applied in a sine wave, a square wave, or a sawtooth wave.

Statement 18 (“S18”). The method of S11-16, or S17 wherein the sonic energy is applied with different amplitudes, different frequencies, or waveforms during removal of unwanted material from around the additively manufactured object.

Statement 19 (“S19”). The method of S11-S17, or S18 further comprising: sensing progress of material removal, and
adjusting operating parameters for applying the sonic energy based on the sensed progress.

Statement 20 (“S20”). The method of S11-S18, or S19 further comprising rotating the platform on which the additively manufactured object had been placed.

Statement 21 (“S21”). The method of S11-S19, or S20 further comprising vibrating the platform on which the additively manufactured object had been placed.

Statement 22 (“S22”). The method of S11-S20, or S21 further comprising conveying the additively manufactured object from a location where the additively manufactured object was formed to the chamber.

Statement 23 (“S23”). The method of S11-S21, or S22 further comprising:
after removing unwanted material from around the additively manufactured object, storing information about removal of unwanted material from the additively manufactured object;
forming a profile for removal of unwanted material from a similar additively manufactured object; and
storing the profile in a profile database from which the profile can be retrieved.

Statement 24 (“S24”). The method of S11-S22, or S23 further comprising maintaining the chamber at a pressure higher or lower than atmospheric pressure.

Statement 25 (“S25”). The method of S11-S23, or S24 further comprising heating the chamber.

Statement 26 (“S26”). The method of S11-S24, or S25 further comprising cooling the chamber.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

1. A system for removal of unwanted material from an additively manufactured object comprising:
a support platform for holding the additively manufactured object; and
at least one audio transducer that applies sonic energy to the additively manufactured object on the support platform, whereby the unwanted material around the additively manufactured object is removed.

2. The system of claim 1 further comprising at least one camera oriented to capture imagery of the additively manufactured object on the support platform.

3. The system of claim 1 further comprising at least one sensor, wherein the at least one sensor comprises a microphone, a thermometer, a scanner, or a scale adapted to weigh the additively manufactured object and/or the unwanted material on the support platform.

4. (canceled)

5. The system of claim 1 further comprising:
an amplifier operatively connected to the at least one audio transducer; and
a controller operatively connected to the amplifier, wherein the controller outputs a signal that applies operating parameters for causing the amplifier to power the at least one audio transducer.

6. The system of claim 1 further comprising:
a profile database containing recipes, wherein each recipe associates operating parameters for operating the at least one audio transducer with at least one characteristic of different additively manufactured objects or unwanted material associated with different additively manufactured objects, and
a controller operatively connected to the profile database and the at least one audio transducer, wherein the controller is operatively adapted to output a signal that applies the operating parameters in a recipe selected from the profile database to the at least one audio transducer.

7. The system of claim 1 further comprising a chamber containing the support platform and the at least one audio transducer, wherein an interior wall of the chamber is anechoic.

8. (canceled)

9. (canceled)

10. The system of claim 1 further comprising at least one wave guide associated with the at least one audio transducer and operative to facilitate directing the sonic energy.

11. A method for removal of unwanted material from an additively manufactured object comprising:
placing the additively manufactured object on a platform in a chamber, and
directing sonic energy at the additively manufactured object located on the platform, whereby the unwanted material around the additively manufactured object is removed.

12. The method of claim 11 further comprising:
selecting a profile that associates at least one characteristic of the additively manufactured object with at least one operating parameter for applying the sonic energy,
wherein the at least one characteristic of the additively manufactured object is one of: a size of, a geometry of, a material composition of, or a process used to manufacture the additively manufactured object or the unwanted material around the additively manufactured object, and
wherein the at least one operating parameter is one of: a runtime, a temperature, a sonic waveform, a sonic amplitude, or a sonic frequency, and
wherein the step of directing sonic energy further comprises directing the sonic energy with the at least one operating parameter in the selected profile.

13. The method of claim 11 further comprising removing the unwanted material from the chamber.

14. (canceled)

15. The method of claim 11 further comprising spraying a liquid chemical detergent at the additively manufactured object located on the platform.

16. The method of claim 11 further comprising changing direction at which the sonic energy is directed at the additively manufactured object located on the platform.

17. The method of claim 11 wherein the sonic energy is applied in a sine wave, a square wave, or a sawtooth wave.

18. The method of claim 11 wherein the sonic energy is applied with different amplitudes, different frequencies, or waveforms during removal of unwanted material from around the additively manufactured object.

19. The method of claim 11 further comprising:
sensing progress of material removal, and
adjusting operating parameters for applying the sonic energy based on the sensed progress.

20. The method of claim 11 further comprising rotating the platform on which the additively manufactured object had been placed.

21. The method of claim 11 further comprising vibrating the platform on which the additively manufactured object had been placed.

22. (canceled)

23. The method of claim 11 further comprising:
after removing unwanted material from around the additively manufactured object, storing information about removal of unwanted material from the additively manufactured object;
forming a profile for removal of unwanted material from a similar additively manufactured object; and
storing the profile in a profile database from which the profile can be retrieved.

24. The method of claim 11 further comprising maintaining the chamber at a pressure higher or lower than atmospheric pressure.

25. The method of claim 11 further comprising heating or cooling the chamber.

26. (canceled)
